(19) United States
(12) Patent Application Publication
(10) Pub. No.: US 2010/0031235 A1
(43) Pub. Date: Feb. 4, 2010

(54) Resource Double Lookup Framework

(75) Inventor: Alexander Volkov, Port Coquitlam (CA)

Correspondence Address: QUARLES & BRADY LLP, ONE SOUTH CHURCH AVENUE, SUITE 1700, TUCSON, AZ, 85701-1621, US

(73) Assignee: MODULAR MINING SYSTEMS, INC., Tucson, AZ (US)

(21) Appl. No.: 12/184,940

(22) Filed: Aug. 1, 2008

(51) Int. Cl. G06F 9/44

(52) U.S. Cl. 717/120

(57) ABSTRACT

A system and method for localizing software having resource references and a resource library. A record of all resource calls performed by the software is generated. New resources are added to the resource library, and instructions are included, that map individual resource calls to resources in the resource library.

### FIELD OF THE INVENTION

The invention relates generally to software localization, which is the configuration of software for use by users of various languages, for example, languages that are different from the language in which the software source code was originally written.

### BACKGROUND

A common challenge to be overcome when developing software for a global market is localization. Localization is the process by which a software engineer customizes a piece of software for use in a local area. Among other tasks, the localization process requires that the software engineer translate words and phrases in the software's user interface into the locally used language.

In order to assist in the process of localization, software developers have conventionally relied on the use of resource libraries. FIG. 1 shows a conventional arrangement for software localization. Software 100 includes an application 103. Application 103 can be an operating system, a custom application, or any other sequence of executable instructions. Application 103 is embodied in computer source code. Application 103 includes a procedure 105, which is module of executable instructions for performing some discrete function. Procedure 105 includes a number of resource references 110a, 110b. Resource references 110a, 110b are variables or placeholders that reference resources that are defined externally to the procedure 105 and application 103.

Software 100 also includes a resource manager 125. Resource manager 125 is a software module that executes a process that maps resource references into calls to resources that are defined in a resource library. In the example of the conventional arrangement of FIG. 1, resource manager 125 is depicted as a stand alone process, but the functionality of resource manager 125 can be included in the source code of procedure 105, or can be defined elsewhere. Resource manager 125 optionally includes resource mapping instructions 130 that provide mapping between resource references 110a, 110b in procedure 105 and resources defined in resource libraries.

Software 100 also includes a resource library 115. Resource library 115 is a user configurable database, table or list of resources that are called or accessed by procedures (e.g., 105) included in application 103. Resource library 115 includes a number of resources 120a, 120b. Resources 120a, 120b are software objects, for example, text strings, numerical values, pictures, functions or procedures, that correspond to resource references.

When application 103 executes procedure 105, the application 103 calls resources 120a, 120b (using the resource manager 125) that correspond to the resource references 110a, 110b. For example, resource reference 110a may be a string variable “f” in the source code that embodies application 103. When an instruction containing string variable “f” is executed, application 103 calls resource library 115 (through the resource manager 125) to find the value corresponding to string variable “f” in corresponding resource 120a. Resource 120a may be a string with the text content “fish”.

The use of resource libraries that are called by the applications allow software developers to write more compact and efficient source code because the software developer need define resources only once in the resource library, then including multiple references to the same resource in the source code. Typically, a resource reference will be reused by an application many times throughout the application's execution, by repeated calls to the same resource whenever the application needs to access that resource. The reuse of resources provides an efficiency advantage as the resource (e.g., 120a) need only be defined once in the resource library 115, and it is accessible by multiple resource references (i.e., multiple occurrences of the resource reference 110a in the executable code of procedure 105) in the application 103. The use of resource libraries also ideally allows for the customization of software without modification to source code by allowing a localization engineer to change the values or content of resources called by the application. Instead of going through the source code of the application in order to change every resource reference, a developer customizing a piece of software need only change the resources in the resource library that the application calls, and the changed resource will be accessed every time the application references the corresponding resource.

Conventional systems for localization of resources are found in several different forms. In a closed architecture where a software producer sells only executable code, the compiling and linking process can incorporate all of the resources referenced in source code directly into the resulting executable file. In this system, resource localization is done internally at the software producer, but the software localization process is usually performed by a localization engineer who works separately from the source code developer. In other more open systems, the resource library, and tools to perform localization are provided to end users or third-parties that perform local customization. In certain conventional systems, the application is still sold as an executable module but the software package includes a customization tool that allows a third-party to customize a resource library by changing default resources accessed by the executable module. In these conventional systems, there is a one to one correspondence between the resources referenced in the executable code of the application and the resources in the resource library.

Reliance on conventional methods of using resource libraries to perform software customization can cause problems. For example, suppose that an application is required to display the word “fish” multiple times during its execution. The conventional method of providing this function is to include resource references in the application source code, for example a string variable “f”, and a corresponding resource in the resource library, the text “fish”. Every occurrence of the variable “f” in the execution of the application calls the resource library and returns the text “fish”, which the application displays. Ideally, in order to customize an application for use in an area with a different language, a localization engineer only needs to change the content of the resource library. A localization engineer would replace the English text “fish” in the resource library with the appropriate word in the local language. Then, when the application runs, the application's resource calls return locally correct content.

This system is effective so long as there is a one-to-one correspondence between words of different languages. Unfortunately, this is seldom the case. In English, the same word “fish” is used to denote both an aquatic animal that breaths through gills, and that same animal prepared as food. In Spanish however, there are separate words for these two things: pez which denotes an aquatic animal and pescado which denotes a dish made from the aquatic animal. In English a one-to-one correspondence between a resource reference in source code and a single text resource in a library for the word “fish” is not a problem. If an application is being localized for a Spanish speaking locale, however, changing the resource in the library from “fish” to “pez” might create problems if “pez” is not contextually appropriate for all of the resource references in the application.

By way of actual example, during initialization of the Microsoft WINDOWS operating system, WINDOWS displays a screen that includes the word “Welcome”. In English, the word “welcome” has a variety of meanings depending on context. “Welcome” can be (1) a noun, meaning “a greeting upon arrival” (e.g. “A warm welcome”); (2) a verb, meaning “to greet hospitably” (e.g. “It is a pleasure to welcome you to our home”); (3) an adjective, meaning “received with gladness” (e.g. “Your letter was very welcome”); and, finally, (4) an interjection, an exclamation used to express a greeting to a guest or newcomer upon arrival (e.g. “Welcome to our home!”). For versions of WINDOWS XP that have been localized to Russian-speaking locales, the “welcome” on the home screen has been translated to the Russian as a noun (meaning “a greeting”), which is contextually inappropriate, since originally an exclamation was intended (namely, “Welcome [to WINDOWS XP Operating System!]”).

Unfortunately, source code developers cannot anticipate all of the various scenarios under which a resource reference will need to be mapped to multiple references during localization. A localization engineer, who is tasked with localizing an application to a particular locale will recognize that word resources are being inappropriately displayed, but the localization engineer can only edit the one resource in the resource library that is being called by all of the corresponding resource references in the application. The conventional solution for this problem is for the localization engineer to request a new source code build that includes the required multiple resource references. This requires another iteration of source code development, which may be repeated multiple times for different localizations for different locales.

### SUMMARY OF THE INVENTION

In certain embodiments, the invention includes a computer program product embodied in a computer readable medium, the computer program product comprising a source code including a plurality of resource references, a resource library including a plurality of default resources, with each default resource corresponding to one or more of the plurality of resource references, a default resource manager including instructions for mapping one or more of the plurality of resource references to one or more of the default resource references in the resource library, and a resource call index reciting a list of all resource calls made by the source code, wherein each entry in the resource call index uniquely identifies each resource call.

In certain embodiments, the resource library includes a new resource not associated with any of the plurality of resource references included in said source code. Certain embodiments include a double resource lookup manager including instructions for mapping an entry in the resource call index to the new resource. Still other embodiments include an override file, wherein the override file includes resource calls that are not mapped to default resources, and wherein, the double resource lookup manager includes instructions de-referencing resource calls included in the override file from their default resources.

In certain embodiments a method of localizing software is provided, the method comprising providing a source code including computer executable instructions including a plurality of resource references, wherein each occurrence of a resource reference in the source code generates a resource call that retrieves a default resource corresponding to the resource reference that generated the resource call, providing a resource library having a plurality of default resources corresponding to the plurality of resource references in the source code; and providing an index of resource calls, wherein the index of resource calls includes a list of all resource calls made by the source code, and wherein each entry in the resource call index uniquely identifies each resource call.

In certain embodiments, the method includes not retrieving a default resource corresponding to a resource reference that generated a resource call, thereby generating a de-referenced resource call. In other embodiments, the method includes, adding a new resource to the resource library; and mapping the de-referenced resource call to the new resource in the resource library. In some embodiments, providing an index of resource calls comprises executing the source code and tracking resource calls made during execution of the source code. In other embodiments, providing an index of resource calls comprises including unique identifiers in the source code for each resource call. In still other embodiments, providing an index of resource calls comprises automatically scanning the source code for resource calls.

In certain embodiments, preventing at least one resource call from retrieving a corresponding default resource, thereby generating a de-referenced resource call comprises providing an override file containing the at least one resource call.

Certain embodiments provide a computer program product, encoded in computer readable medium. The computer program product comprises a source code comprising a plurality of resource references, wherein when said source code is executed each occurrence of a resource reference generates a resource call that retrieves an associated default resource, a resource library comprising a plurality of default resources, and an index of resource calls reciting each occurrence of a resource call that occurs when said source code is executed.

In certain embodiments, the computer program product further comprises computer readable program code which causes a programmable computer processor to detect an override file, computer readable program code which, if no override file is detected, causes a programmable computer processor to map each of said plurality of resource references to an associated default resource, and computer readable program code which, if an override file is detected, causes a programmable computer processor to identify each resource call included in said override file.

In other embodiments, the resource library further comprises one or more newly-defined resources, and the computer program product further comprising computer readable program code which, if an override file is detected, causes a programmable computer processor to map each resource call included in said override file to a newly defined resource.

### BRIEF DESCRIPTION OF THE DRAWINGS

FIG. 1 is a block diagram showing a conventional arrangement of software objects including a resource library.

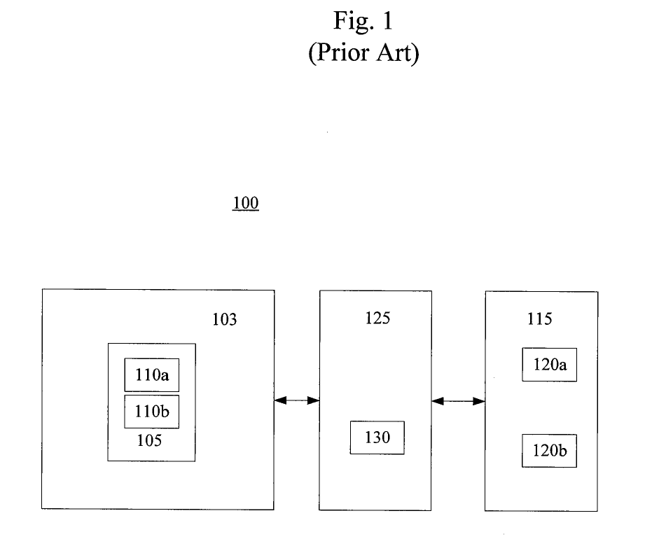

FIG. 2 is a block diagram showing an arrangement of software objects including a resource library according to an embodiment of the invention.

FIG. 3 is a flow chart showing a method performed by a double resource lookup resource manager acting in accordance with an embodiment of the invention.

FIG. 4 is a flow chart showing a method to perform software localization method according to an embodiment of the invention.

### DETAILED DESCRIPTION OF THE PREFERRED EMBODIMENTS

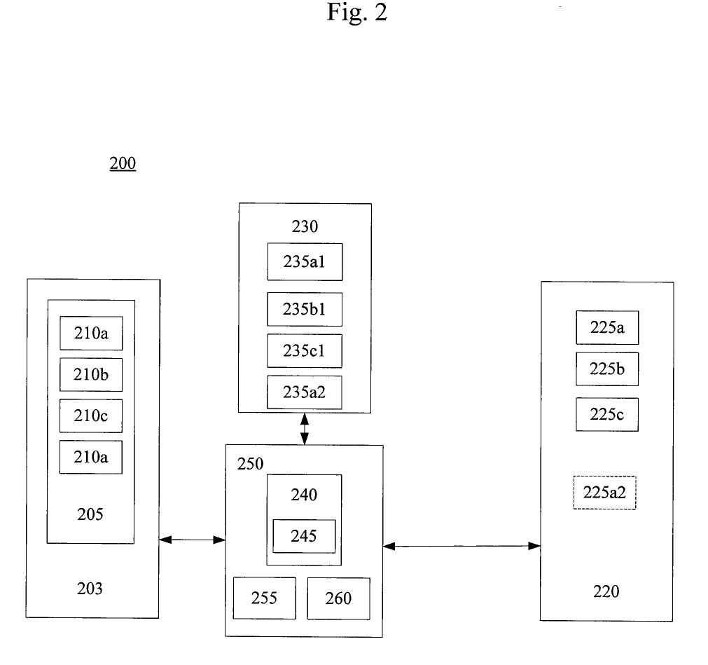

Some of the functional units described in this specification have been labeled as modules (e.g., modules 240, 250 FIG. 2) in order to more particularly emphasize their implementation independence. A module (e.g., modules 240, 250 FIG. 2) may be implemented as a hardware circuit comprising custom VLSI circuits or gate arrays, off-the-shelf semiconductors such as logic chips, transistors, or other discrete components. A module (e.g., modules 240, 250 FIG. 2) may also be implemented in programmable hardware devices such as field programmable gate arrays, programmable array logic, programmable logic devices, or the like.

Modules (e.g., modules 240, 250 FIG. 2) may also be implemented in software for execution by various types of processors. An identified module of executable code may, for instance, comprise one or more physical or logical blocks of computer instructions which may, for instance, be organized as an object, procedure, or function. Such functional blocks may be described generally as “logic”. Nevertheless, the executables of an identified module (e.g., modules 240, 250 FIG. 2) need not be physically located together, but may comprise disparate instructions stored in different locations which, when joined logically together, comprise the module and achieve the stated purpose for the module.

Indeed, a module of executable code (e.g., modules 240, 250 FIG. 2) may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

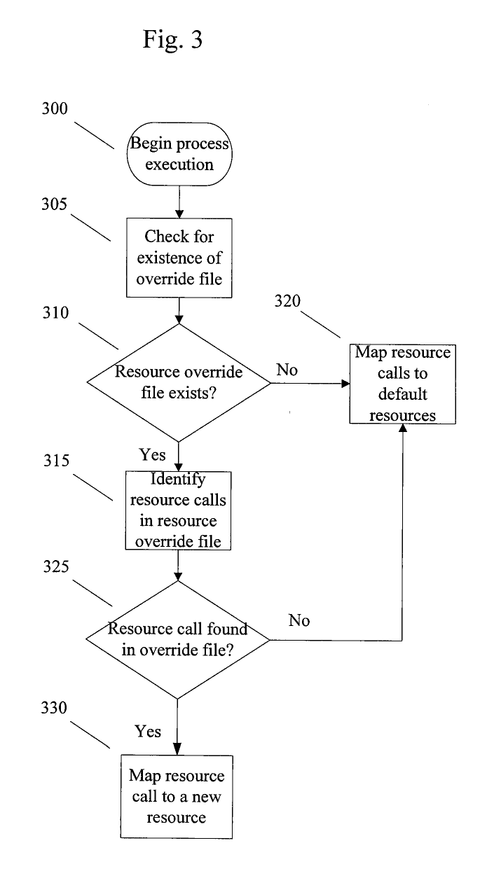

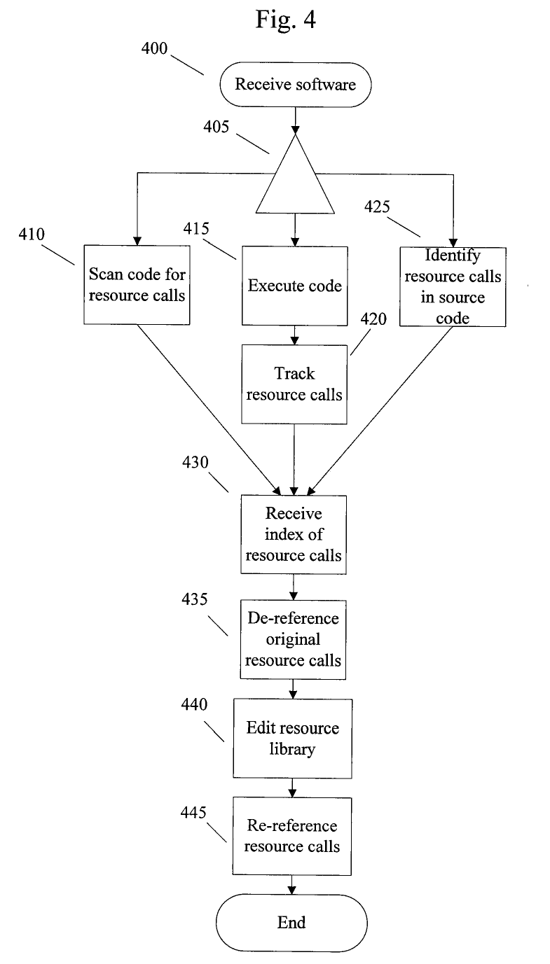

The schematic flow chart diagrams included are generally set forth as logical flow-chart diagrams (e.g., FIGS. 3 and 4). As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow-chart diagrams, they are understood not to limit the scope of the corresponding method (e.g., FIGS. 3 and 4). Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown. Moreover, steps may be combined or omitted without taking a particular embodiment out of the scope of the invention.

The described operations may be implemented as a method, apparatus or article of manufacture using standard programming and/or engineering techniques to produce software, firmware, hardware, or any combination thereof. The described operations may be implemented as code maintained in a “computer readable medium”, where a processor may read and execute the code from the computer readable medium.

A computer readable medium may comprise media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. The code implementing the described operations may further be implemented in hardware logic implemented in a hardware device (e.g., an integrated circuit chip, Programmable Gate Array (PGA), Application Specific Integrated Circuit (ASIC), etc.). Still further, the code implementing the described operations may be implemented in “transmission signals”, where transmission signals may propagate through space or through a transmission media, such as an optical fiber, copper wire, etc.

The transmission signals in which the code or logic is encoded may further comprise a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a computer readable medium at the receiving and transmitting stations or devices.

An “article of manufacture” or “computer program product” comprises computer readable medium, hardware logic, and/or transmission signals in which code may be implemented. A device in which the code implementing the described embodiments of operations is encoded may comprise a computer readable medium or hardware logic. Of course, those skilled in the art will recognize that many modifications may be made to this configuration without departing from the scope of the present invention, and that the article of manufacture may comprise suitable information bearing medium known in the art.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

Embodiments of the invention are based on the idea of indexing all the resource calls performed by a procedure embodied in source code by providing each resource call with a unique identifier. Once resource calls have been indexed, the procedure accesses resources in a resource library indirectly through a double lookup resource manager or wrapper. The double lookup resource manager checks whether each uniquely identified resource call has been overridden by a flag set in an override file. In the case where a resource call has not been overridden, the resource call retrieves the resource originally associated with the resource reference in the source code. If a resource call has been overridden, the resource call is mapped to a new resource defined specifically for that call in the resource library. For example, in the event of a conflict in contextual meanings between the two different resource calls referencing the same resource (e.g. “pez” and “pescado” calls referencing the same resource “fish”), the localization engineer obtains the ability (1) to create a new resource in the resource library, (2) override the incorrect call, and (3) re-reference it to the newly created resource using the unique identifier of that resource call. The index of resource calls is created either at the stage of software development by the author of the source code, through an automated procedure that scans already drafted source code for resource calls, or by executing the procedure and tracking the resource calls made during the procedure's execution.

FIG. 2 shows an arrangement of software objects 200 according to an embodiment of the invention. The arrangement of software objects of FIG. 2 includes an application 203. Application 203 can be an operating system, a custom application, and/or any other sequence of executable instructions. Application 203 is embodied in source code. Application 203 includes one or more procedures, 205. Procedure 205 is a module of executable instructions for performing some discrete function or series of functions. Procedure 205 includes one or more resource references 210a, 210b, 210c. Resource references 210a, 210b, 210c are variables or placeholders that reference resources that are defined external to the procedure 205 and application 203. For example, resource references 210a, 210b, 210c could be string, integer, real, or Boolean variables, or more complex composite variables such as structures in the C, and C derivative, programming languages. The presence of resource references 210a, 210b, 210c in procedure 205 causes the procedure 205 to call externally defined resources that are defined, for example, in external resource libraries.

The arrangement of FIG. 2 includes a resource library 220. Resource library 220 is a user configurable database, table or list of resources that are called by procedure 205. Resource library 220 contains one or more resources 225a, 225b, 225c. Examples of resources 225a, 225b, 225c include text strings, numerical values, pictures, or more complex collections of data that correspond to resource references 210a, 210b, 210c. Resources may also be, themselves, functions or calls to other resources defined in the resource library 220 or elsewhere. When procedure 205 reaches a resource reference 210a, 210b, 210c during its execution, the procedure 205, with or without the assistance of other software modules, calls the resource library to retrieve the corresponding resources 225a, 225b, 225c. Resource references 210a, 210b, 210c can be used multiple times throughout a procedure 205 or among multiple procedures running as part of a piece of software. This saves memory, storage space and programming effort by allowing a single resource, e.g., 225a, to be mapped to or called by multiple resource references, e.g., 210a. In the exemplary arrangement of FIG. 2, for example, resource reference 210a occurs in procedure 205 twice, and so procedure 205, with or without the assistance of other software modules, would call corresponding reference 225a twice during procedure 205's execution. Resource library 220 may be edited, for example, by a localization engineer, to change the definition of resources and to add new resources not included in the original software build. In the example of FIG. 2, resource library 220 has been edited to add a new resource 225a2.

The arrangement of FIG. 2 includes a default resource manager 240. Default resource manager 240 is a software process that maps resource references into calls to resources defined in a resource library. In the example of the arrangement of FIG. 2, default resource manager 240 is depicted as a stand alone process, but the functionality of default resource manager 240 can be included in the source code of procedure 205, or can be defined elsewhere. Default resource manager 240 causes resources, for example, 225a, 225b, 225c to be associated with resource references 210a, 210b, 210c. Default resource manager 240 optionally includes default resource mapping instructions 245 that provide mapping between resource references 210a, 210b, 210c in procedure 205 and resources 225a, 225b, 225c defined in resource library 220.

The arrangement of FIG. 2 includes a resource call index 230. Resource call index 230 is an ordered list of all of the resource calls executed by procedure 205. In the example of FIG. 2, resource call index 230 contains an ordered list of resource call records 235a1, 235b1, 235c1, and 235a2. Resource call records 235a1, 235b1, 235c1, and 235a2 represent every individual call of a resource performed by procedure 205. Resource call records 235a1, 235b1, 235c1, and 235a2 include unique identifiers for each individual resource call. Resource call records 235a1, 235b1, 235c1, and 235a2 are optionally arranged in resource call index 230 according to the order with which resource calls occur during execution of procedure 205, but this is not necessary so long as every individual resource call made by procedure 205 is uniquely identifiable by its record in the resource call index 230. In the example of FIG. 2, resource call records 235a1, 235b1, 235c1, and 235a2 correspond to the procedure 205's sequential use of resource references 210a, 210b, 210c and 210a again. In one embodiment, resource call records 235a1, 235b1, 235c1, and 235a2 contain a first name component that is equivalent to the resource reference in the source code that results in software 200, and a second name component that refers to the number of times that resource has been referenced or called. For example, suppose that resource references 210a, 210b and 210c were represented in the original source code that resulted in software 200 as string variables “f”, “b” and “p”. Under this example, resource call records 235a1, 235b1, 235c1, and 235a2 might be labeled “f1”, “b1”, “p1” and “f2”. Alternatively, the first name component could be a portion of or the entire name of the resource in the resource library that corresponds to the resource reference.

In one embodiment, resource call index 230 is included in the source code that embodies procedure 205. In this embodiment, the source code author, when providing code including resources references 210a, 210b, 210c, also optionally includes an index of all resource calls in the source code. Where the resource call index 230 is included in the source code that embodies procedure 205, the resource call index 230 may be provided as an appendix to the source code, or may be distributed throughout the source code with each resource call being included with each resource reference. Alternatively, the resource call index 230 can exist as a separate file or database that exists apart from the source code that embodies application 205. Where the resource call index 230 exists as a separate file from the source code, the resource call index 230 can be built manually by an examination of the source code embodying procedure 205, or is generated automatically by an automated scan of the source code that embodies procedure 205.

The arrangement of FIG. 2 includes a double lookup resource manager 250. Double lookup resource manager 250 is implemented as a custom wrapper on default resource manager 240. Double lookup resource manager 250 includes an override file 255. Override file 255 is a configurable file that can be edited by a localization engineer, which contains a list of resource calls that should be de-referenced from their default resources and re-referenced to new resources created by the localization engineer. Alternatively, override file 255 is an array of sub-files, with each sub-file being associated with a particular resource reference, and where each sub-file contains resource calls that should be de-referenced from their default resource and re-referenced to new resources created by the localization engineer. When procedure 205 encounters a resource reference, the default resource manager 240 conventionally maps the resource reference into a resource call 235a1 to a resource, for example, resource 225a. In the exemplary arrangement of FIG. 2, resource reference 210a, which refers to resource 225a, occurs twice. The presence of the second resource call 235a2, which represents the second occurrence of resource reference 210a in procedure 205, in the override file 255 de-references that resource call. Suppose, for example, that the first reference (the first occurrence of 210a) to resource 225a that occurs in procedure 205 is contextually appropriate, but the second reference (second occurrence of 210a) to resource 225a that occurs in procedure 205 is inappropriate. The second reference to resource 225a is identified as resource call 235a2 in the resource call index 230. Since mapping resource call 235a2 (the second use of resource reference 210a) is inappropriate, resource call 235a2 is included in the override file 255. The presence of a resource call in the override file causes the double lookup default resource manager 240 to de-reference the resource call, that is, disable the default mapping arrangement whereby the resource manager would ordinarily map the second occurrence of resource reference 210a to resource 225a.

Double lookup resource manager 250 also includes resource mapping instructions 260. Resource mapping instructions 260 provide new mapping instructions for all resource calls that are included in the override file 260. For example, in the case where resource call 235a2 should not map to original resource 225a, resource mapping instructions 260 would include instructions sufficient to implement the rule, “resource call 235a2 maps to new resource 225a2.” The use of double lookup resource manager 250 as a process that overlays the conventionally provided default resource manager 240, allows for the efficiency advantages of resource libraries to be preserved while simultaneously allowing flexibility in customization. Since the default resource manager 240's default mapping instructions 245 map all resource reference calls to their default resources until a particular resource call is de-referenced by inclusion in the override file 260, a localization engineer can preserve all resource calls in their default condition and only re-reference the resource calls that require new resources.

In the example of FIG. 2, under a default arrangement, resource reference 210a occurs twice in procedure 205. Under a default arrangement, resource reference 210a references resource 225a in the resource library 220. In the example set forth above, procedure 205 calls resource 225a twice, through the default resource mapping instructions 245 in default resource manager 240. These two resource calls are indicated by resource call records 235a1 and 235a2 in the resource call index 230. A localization engineer who is translating a resource library for use in a locality may find that resource 225a is appropriate for the first call 235a1, but inappropriate for the second call 235a2. In such a circumstance, the localization engineer adds a new resource 225a2 to the resource library 220, de-references resource call 235a2 by including resource call 235a2 in the override file 255, and changes mapping instructions 260 in the double lookup resource manager 250. The new instructions are changed to implement the rule, “resource call 235a2 maps to resource 225a2.”

In the exemplary embodiment of FIG. 2, suppose that originally resource references 210a mapped to resource 225a, where resource 225a is a text string “fish”. Suppose further that a localization engineer is configuring software 200 for use in a Spanish-speaking locale. Generally, a localization engineer would start the localization process by translating all of the text strings in the default resource library into their Spanish equivalents. In the present example, the localization engineer might choose the Spanish word “pez” to replace the English word “fish” in resource 225a. Upon executing the localized software, localization engineer might encounter usages of resource 225a for which the Spanish word “pez” was inappropriate. For example, software 200 might contain references to both fish as aquatic animals that breathe through gills, and aquatic animals that breathe through gills prepared as food for people. In English, the word “fish” is appropriate for both these concepts, so all resource references, e.g., 210a, can map to the same resource 225a, the word “fish”, without any problems. In Spanish however, a first call 210a of resource 225a might occur as part of a function where it is appropriate to display a word referring to fish as an animal, while a second call 210a of resource 225a might occur as part of a function where it is appropriate to display a word referring to fish as a dish. Embodiments of the invention contain or build an index 230 of all the individual calls of resources. A localization engineer could then translate resource 225a as “pez”, the Spanish word for fish as an animal, and add a new resource 225a2 for “pescado”, the Spanish world for fish as a dish. The localization engineer then de-references the second resource call to 225a by adding resource call 235a2 to override file 255. The localization engineer then re-references resource call 235a2 to new resource 225a2 by adding appropriate instructions to the resource mapping instructions 260 of the double lookup resource manager 250. In this way, the localization engineer can create any number of new resources and map individual resource calls to the new references without having to alter the source code. This provides an efficient trade-off between resource reuse and resource specificity in different languages by preserving the advantages of the use of resource libraries (i.e., allowing a small number of resources to be mapped to multiple references in source code) while allowing the flexibility to stop reusing a resource in specific cases as required by the target language. One major advantage is the ability to perform effective software localization without having to modify the source code and re-release the software package. Another advantage of embodiments of the invention is that they remove the responsibility of dealing with contextual subtleties from the developer, who is free to reuse resources freely in the drafting of source code.

The mapping of resource calls to resource in the resource library can be achieved in other ways. For example, in one embodiment, the localization engineer adds override file 255 to the double lookup resource manager 250. In the absence of an override file 255, the default resource manager 240 executes default resource mapping instructions 245 normally, i.e., by mapping every resource reference in the procedure 203's source code to its corresponding default resource in the resource library 220. In one embodiment, the existence of override file 255 causes the double lookup resource manager 250 to look to the override file to locate resource calls that have been overridden. Where an entry exists in override file 255, double lookup resource manager 250 looks to resource mapping instructions 260 to map the resource call that has been overridden to a new resource that has been created. All other resources references are mapped to their original resources through the default resource mapping instructions 245.

The mapping of resource calls to new resources in the libraries can be achieved in still other ways. For example, in certain embodiments, resource calls 235a1, 235b1, 235c1, 235a2 include flags, which when set to a first default value, preserve the default mapping arrangement, but when set to a second predetermined value, disable the default mapping arrangement. This in the example of FIG. 2, a localization engineer wanting to re-reference resource call 235a2 could set a flag to the second predetermined value, which de-references the original mapping of resource call 235a2 to resource 225a. The localization engineer would then add new resource 225a2 and include new mapping instructions to map resource call 235a2 to new reference 225a2. The precise functionality for de-referencing then re-referencing particular resource calls can be implemented either in terms of a separate software module such as double lookup default resource manager 250 or can be implemented elsewhere.

FIG. 3 shows a method performed by a double lookup resource manager according to an embodiment of the invention for mapping resource calls to resources. The method of FIG. 3 may be implemented, for example, by the double lookup resource manager 250 described with reference to FIG. 2. In 300, a software process containing resource reference is executed. In 305, an embodiment of the invention checks for the existence of an override file. The method considers whether an override file exists 310. In 320, in the event that an override file does not exist, the resource references in the original software process are mapped to their associated default resources in a resource library. In 315, in the event that an override file does exist, the method identifies resource calls in the override file. In 325, for resource calls not in the override file, those resource calls are mapped to the default resources that correspond to the resource references that generated those resource calls. In 330, for resource calls that are present in the override file, those resource calls are mapped to new resources.

FIG. 4 is a flowchart showing a method of software localization according to an embodiment of the invention. In 400, a localization engineer receives software. The software can comprise source code for executing an application including one or more procedures, executable code for executing an application including one or more procedures, a resource manager, and/or a resource library. The software has one or more resource references defined externally to the one or more procedures, for example in a resource library. In 405, multiple alternative methods are represented for generating a resource call index. In a first alternative 410, the source code of the software is scanned to find resource calls. The scan may be made manually by a localization engineer or the original source code author, or may be performed by an automated process. In a second alternative 415, the source code of the software is compiled than executed (or in the event that the software is received in executable form, just executed) and resource calls made by the software are tracked 420. In a third alternative 425 the software's source code author has included an index of resource calls in the source code, and the localization engineer identifies the resource calls. After the resource call index has been generated, the localization engineer receives the resource call index 430. In 435 resource calls that require new resources are de-referenced. In 440 the resource library is edited to provide new and/or different resources. In 445 resource calls are mapped to new and/or different resources in the edited resource library. The method described with reference to FIG. 4 can be optionally limited to re-referencing only those resource calls for which re-referencing is desired. Default resource references can be left to reference default resources where appropriate.

It is important to note that the method of the present invention can be applied to resources of any type including text strings, numerical values, pictures, or even complex resources such as data structures or other procedures. Moreover, the method of the invention can be applied to any existing piece of software (compiled or interpreted) that uses resource libraries (or any type of resources), and is therefore not limited to modification of software for localization. Embodiments of the invention have additional advantages as well. For example, in certain cases, even in cases where translation of library resources into a local language is straightforward, a software user interface presented to a user after localization can be suboptimal. This may occur, for example, where an English word is translated into a longer word in the local language. Even where the local word is correct contextually, the user interface can appear strange or lack required text in such situations. The method of the present invention allows the localization engineer to correct this by defining resources differently for different user interface presentation situations.

While the preferred embodiments of the present invention have been illustrated in detail, it should be apparent that modifications and adaptations to those embodiments may occur to one skilled in the art without departing from the scope of the present invention as set forth in the following claims.

We claim:

1. A computer program product embodied in a computer readable medium, the computer program product comprising:
a source code including a plurality of resource references;
a resource library including a plurality of default resources, with each default resource corresponding to one or more of the plurality of resource references;
a default resource manager including instructions for mapping one or more of the plurality of resource references to one or more of the default resource references in the resource library;
a resource call index reciting a list of all resource calls made by the source code, wherein each entry in the resource call index uniquely identifies each resource call.

2. The computer program product of claim 1, wherein the resource library includes a new resource not associated with any of the plurality of resource references included in said source code.

3. The computer program product of claim 2, further comprising a double resource lookup manager including instructions for mapping an entry in the resource call index to the new resource.

4. The computer program product of claim 3, further comprising an override file, wherein the override file includes resource calls that are not mapped to default resources, and wherein, the double resource lookup manager includes instructions de-referencing resource calls included in the override file from their default resources.

5. A method of localizing software comprising:
providing a source code including computer executable instructions including a plurality of resource references, wherein each occurrence of a resource reference in the source code generates a resource call that retrieves a default resource corresponding to the resource reference that generated the resource call;
providing a resource library having a plurality of default resources corresponding to the plurality of resource references in the source code;
providing an index of resource calls, wherein the index of resource calls includes a list of all resource calls made by the source code, and wherein each entry in the resource call index uniquely identifies each resource call.

6. The method of claim 5, further comprising:
not retrieving a default resource corresponding to a resource reference that generated a resource call, thereby generating a de-referenced resource call.

7. The method of claim 6 further comprising:
adding a new resource to the resource library; and
mapping the de-referenced resource call to the new resource in the resource library.

8. The method of claim 5, wherein providing an index of resource calls comprises executing the source code and tracking resource calls made during execution of the source code.

9. The method of claim 5, wherein providing an index of resource calls comprises including unique identifiers in the source code for each resource call.

10. The method of claim 5, wherein providing an index of resource calls comprises automatically scanning the source code for resource calls.

11. The method of claim 5, wherein preventing at least one resource call from retrieving a corresponding default resource, thereby generating a de-referenced resource call comprises providing an override file containing the at least one resource call.

12. A computer program product, encoded in computer readable medium, comprising:
a source code comprising a plurality of resource references, wherein when said source code is executed each occurrence of a resource reference generates a resource call that retrieves an associated default resource;
a resource library comprising a plurality of default resources;
an index of resource calls reciting each occurrence of a resource call that occurs when said source code is executed;
said computer program product further comprising:
computer readable program code which causes a programmable computer processor to detect an override file;
computer readable program code which, if no override file is detected, causes a programmable computer processor to map each of said plurality of resource references to an associated default resource;
computer readable program code which, if an override file is detected, causes a programmable computer processor to identify each resource call included in said override file.

13. The computer program product of claim 12, wherein said resource library further comprises one or more newly-defined resources, said computer program product further comprising computer readable program code which, if an override file is detected, causes a programmable computer processor to map each resource call included in said override rile to a newly defined resource.
